(19) United States
(12) Patent Application Publication
(10) Pub. No.: US 2026/0322099 A1
(43) Pub. Date: Oct. 15, 2026

(54) CABLE MECHANISM FOR EV CHARGING STATION

(71) Applicant: VOLTPOST, INC., New York, NY (US)

(72) Inventors: Chiraag M. HEBBAR, San Francisco, CA (US); Alejandro Enrique VALLEJO, Oakley, CA (US)

(21) Appl. No.: 19/111,032

(22) PCT Filed: Sep. 12, 2023
(86) PCT No.: PCT/US2023/032565

§ 371 Date: Mar. 12, 2025

Related U.S. Application Data
(60) Provisional application No. 63/375,286, filed on Sep. 12, 2022.

(51) Int. Cl. H02G 11/02; B60L 53/18; B60L 53/30; B65H 75/36

(52) U.S. Cl. CPC H02G 11/02; B60L 53/18; B60L 53/30; B65H 75/368; B65H 2701/34

(57) ABSTRACT

The cable mechanism dispenses and retracts a cable having a free and a fixed end. The cable mechanism includes a motor assembly configured to engage a leading portion of the cable to dispense or retract the cable and a pulley assembly configured to engage a following portion of the cable. The following portion may be arranged between the leading portion and the fixed end of the cable. The pulley assembly may be movable relative to the motor assembly between a first position and a second position. Moving the pulley assembly from the first position to the second position may dispense the cable, and moving the pulley assembly from the second position to the first position may retract the cable.

### CROSS-REFERENCE TO RELATED APPLICATIONS

This application claims priority to the provisional patent application filed Sep. 12, 2022 and assigned U.S. App. No. 63/375,286, the disclosure of which is hereby incorporated by reference.

### FIELD OF THE DISCLOSURE

This disclosure relates to a motorized cable mechanism and, more particularly, to a motorized cable mechanism for dispensing and retracting a cable for charging electric vehicles.

### BACKGROUND OF THE DISCLOSURE

Cables are used to complete all manners of electrical circuits and are useful to connect a power source to a chargeable device (e.g., an electric vehicle (EV)), as the distance between the power source and the chargeable device may vary. While a cable having a long length may generally be desired to increase the possible distance between the power source and the chargeable device, such a long cable can be a nuisance when being stored or in use when shorter amounts of cable are needed. Furthermore, users are generally not dependable to neatly store an unwound cable after use.

Cables can be managed by being wound on a spool, where the spool can be rotated to dispense or retract a desired length of the cable. However, the spool may need a slip ring to maintain a connection with the power source. Slip rings may not be feasible in high voltage or high current applications due to their cost, reliability, or environmental considerations. Spooled cables pose additional problems when used in an active circuit, as the closely wound cable can generate heat at high current. This requires the operating current to be kept dramatically lower than the current rating of the cable. Such a problem is particularly prevalent in EV charging applications, where high current may be desired.

Therefore, what is needed is a cable mechanism that provides a controlled manner of dispensing and retracting a cable and storage thereof.

### BRIEF SUMMARY OF THE DISCLOSURE

An embodiment of the present disclosure provides a cable mechanism for dispensing and retracting a cable having a free and a fixed end. The cable mechanism may comprise a motor assembly configured to engage a leading portion of the cable to dispense or retract the cable and a pulley assembly configured to engage a following portion of the cable. The following portion may be arranged between the leading portion and the fixed end of the cable. The pulley assembly may be movable relative to the motor assembly between a first position and a second position. Moving the pulley assembly from the first position to the second position may dispense the cable, and moving the pulley assembly from the second position to the first position may retract the cable.

In some embodiments, the cable mechanism may further comprise a housing. The motor assembly may be disposed in the housing and the pulley assembly may be vertically movable relative to the motor assembly within the housing.

In some embodiments, the housing may be at least partially sealed. The fixed end of the cable may be disposed within the housing, and the free end of the cable may be disposed outside the housing.

In some embodiments, in the first position, a maximum length of the cable may be disposed within the housing, and in the second position, a minimum length of the cable may be disposed within the housing.

In some embodiments, the pulley assembly may comprise a linear motion guide, a carriage movable along the linear motion guide between the first position and the second position, at least one movable pulley disposed on the carriage, and at least one stationary pulley disposed adjacent to the motor assembly. The following portion of the cable may be looped around the at least one movable pulley and the at least one stationary pulley in series.

In some embodiments, the pulley assembly may further comprise a drive motor configured to drive a drive chain. The carriage may be fixed to the drive chain such that when the drive motor drives the drive chain, the carriage may move along the linear motion guide between the first position and the second position.

In some embodiments, the at least one movable pulley and the at least one stationary pulley may have a diameter of at least 5 times greater than the diameter of the cable.

In some embodiments, the at least one movable pulley and the at least one stationary pulley may be non-parallel such that a successive pulley in each loop of the cable has an input at a location that intersects a plane of a previous pulley in the series.

In some embodiments, the at least one movable pulley and the at least one stationary pulley may comprise a series of pulleys arranged in an arc shape. The arc shape may have an arc radius at least 5 times greater than the radius of the cable.

In some embodiments, the at least one movable pulley may comprise a plurality of movable pulleys, and the at least one stationary pulley may comprise a plurality of stationary pulleys. The following portion of the cable may be alternately looped around one of the plurality of movable pulleys and one of the plurality of stationary pulley in series.

In some embodiments, the motor assembly may comprise an exit motor configured to drive a pair of drive rollers. The leading portion of the cable may be disposed between the pair of drive rollers such that when the exit motor drives the pair of drive rollers, the pair of drive rollers may engage the leading potion of the cable to dispense or retract the free end of the cable.

In some embodiments, the motor assembly may further comprise at least one pair of guide rollers arranged upstream and/or downstream of the pair of drive rollers. The at least one pair of guide rollers may be configured to alter the angular direction in which the cable is dispensed or retracted.

In some embodiments, the cable mechanism may further comprise a drive motor configured to move the pulley assembly between the first position and the second position, an exit motor of the motor assembly configured to dispense or retract the free end of the cable, and a controller configured to synchronize the drive motor and the exit motor such that the cable is under tension between the leading portion and the fixed end when dispensing or retracting.

In some embodiments, the controller may be configured to control the speed of the drive motor to be slower than the speed of the exit motor when the cable is dispensing from the cable mechanism.

In some embodiments, the controller may be configured to control the speed of the drive motor to be slower than the speed of the exit motor when the cable is retracting from the cable mechanism.

In some embodiments, the cable mechanism may further comprise a control switch disposed at the free end of the cable. The control switch may be in electronic communication with the controller. The control switch may be configured to send instructions to the controller to dispense or retract the cable.

In some embodiments, the control switch may be configured to send instructions to the controller to dispense or retract a specified length of the cable.

Another embodiment of the present disclosure provides a method of dispensing or retracting a cable having a free end and a fixed end. The method may comprise providing a cable mechanism. The cable mechanism may comprise a motor assembly configured to engage a leading portion of the cable to dispense or retract the cable and a pulley assembly configured to engage a following portion of the cable, the following portion being arranged between the leading portion and the fixed end of the cable. The pulley assembly may be movable relative to the motor assembly between a first position and a second position.

The method may further comprise moving the pulley assembly from the first position to the second position to dispense the cable, or moving the pulley assembly from the second position to the first position to retract the cable.

In some embodiments, moving the pulley assembly from the first position to the second position, or moving the pulley assembly from the second position to the first position may comprise synchronously controlling a drive motor to move the pulley assembly between the first position and the second position and an exit motor of the motor assembly to dispense or retract the free end of the cable, such that the cable is under tension when dispensing or retracting.

### DESCRIPTION OF THE DRAWINGS

For a fuller understanding of the nature and objects of the disclosure, reference should be made to the following detailed description taken in conjunction with the accompanying drawings, in which:

FIG. 1 is a schematic diagram of a cable mechanism according to an embodiment of the present disclosure;

FIG. 2 illustrates an exemplary cable mechanism according to an embodiment of the present disclosure;

FIG. 3A illustrates the exemplary cable mechanism in a first position;

FIG. 3B illustrates the exemplary cable mechanism in a second position;

FIGS. 4A, 4B, and 4C illustrate the exemplary cable mechanism with detail views of the pulley assembly;

FIGS. 5A and 5B illustrate the exemplary cable mechanism with a detail view of the motor assembly;

FIG. 6A is a schematic diagram of a top view of a pulley assembly of a cable mechanism according to an embodiment of the present disclosure;

FIG. 6B is a schematic diagram of a top view of cable wrapped around a pulley assembly of a cable mechanism according to an embodiment of the present disclosure;

FIG. 6C is a schematic diagram of a top view of a cable wrapped around a pulley assembly of a cable mechanism according to another embodiment of the present disclosure;

FIG. 7 illustrates a top view of a pulley assembly of the exemplary cable mechanism;

FIG. 8A is a schematic diagram of a top view of a pulley assembly of a cable mechanism according to an embodiment of the present disclosure;

FIG. 8B is a schematic diagram of a top view of a pulley assembly of a cable mechanism according to another embodiment of the present disclosure;

FIG. 9A is a flowchart of a method of dispensing or retracting cable according to an embodiment of the present disclosure; and

FIG. 9B is a flowchart of a method of dispensing or retracting cable according to another embodiment of the present disclosure.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

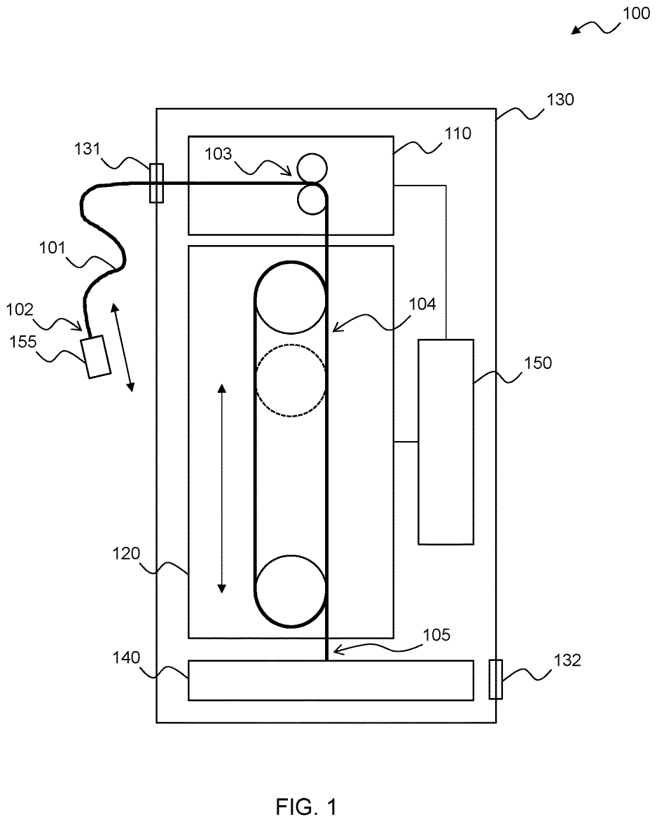

An embodiment of the present disclosure provides a cable mechanism 100 for dispensing and retracting a cable 101, as shown in FIG. 1. The cable 101 may have a free end 102 and a fixed end 105. The cable mechanism 100 may comprise a motor assembly 110 configured to engage a leading portion 103 of the cable 101 to dispense or retract the cable 101 and a pulley assembly 120 configured to engage a following portion of the cable 104. The following portion 104 may be arranged between the leading portion 103 and the fixed end 105 of the cable 101. The pulley assembly 120 may be movable relative to the motor assembly 110 between a first position and a second position. When the pulley assembly 120 is moved from the first position to the second position, the cable 101 may be dispensed, and when the pulley assembly 120 is moved from the second position to the first position, the cable 101 may be retracted. By moving the pulley assembly 120 as the motor assembly 110 dispenses or retracts the cable 101, the cable 101 can be kept under tension between the leading portion 103, the following portion 104, and the fixed end 105, which allows for smooth operation of the cable mechanism 100.

It should be understood that the leading portion 103 and the following portion 104 may refer to different portions of the cable 101 during use of the cable mechanism 100. For example, the leading portion 103 of the cable 101 may change as the cable 101 is dispensed or retracted, as the specific part of the cable 101 engaged with the motor assembly 110 continuously varies as the cable 101 passes through the motor assembly 110. The following portion 104 may also change as the cable 101 is dispensed or retracted, as the amount of the cable 101 engaged with the pulley assembly 120 varies between the first position and the second position. Accordingly, the leading portion 103 and the following portion 104 of the cable 101 shown in the drawings refer to specific instances of the cable 101 in various states of dispensing and retracting by the cable mechanism 100.

The cable mechanism 100 may further comprise a housing 130, and the motor assembly 110 and the pulley assembly 120 may be disposed in the housing 130. For example, the motor assembly 110 may be disposed in an upper portion of the housing 130, and the pulley assembly 120 may be vertically movable within the housing 130 beneath the motor assembly 120. Alternatively, the motor assembly 110 may be disposed in a lower portion of the housing 130, and the pulley assembly 120 may be vertically movable within the housing 130 above the motor assembly 110. In further embodiments, the motor assembly 110 may be disposed in a left or right portion of the housing 130, and the pulley assembly 120 may be horizontally movable within the housing 130 relative to the motor assembly 110. Accordingly, the direction of the movement of the pulley assembly 120 (e.g., vertically, horizontally, or at an angle), may depend on the arrangement of the motor assembly 110 and the pulley assembly 120 within the housing 130. Furthermore, the direction of the movement of the cable 101 (i.e., dispensing or retracting) corresponding to movement of the pulley assembly 120 between the first and second positions may depend on the arrangement of the motor assembly 110 and the pulley assembly 120 within the housing 130. For example, the first position and the second position may refer to a “raised” position or a “lowered” position of the pulley assembly 120 relative to the motor assembly 110. Any specific references to the “raised” position or the “lowered” position herein only refer to exemplary arrangements of the motor assembly 110 and the pulley assembly 120 within the housing 130, and are not believed to be limited herein.

The housing 130 may be at least partially sealed from the exterior. For example, the housing 130 may only have one output opening 131 in which the cable 101 is dispensed or retracted from the housing 130. The housing 130 may thereby protect the motor assembly 110, the pulley assembly 120, and the other components inside the housing 130 from damage that could impact the operation of the cable mechanism 100. The housing 130 may also protect users from contact with (or tampering with) high voltage/high current electrical transmission lines connected to the cable mechanism 100. The housing 130 may also have an input opening 132 to receive input power to connect to the cable 101. The locations of the output opening 131 and the input opening 132 on the housing 130 may vary, and are not limited herein. For example, as shown in FIG. 1, the output opening 131 may be located at an upper portion of the housing 130, and the input opening 132 may be located at a lower portion of the housing 130.

The fixed end 105 of the cable 101 may be disposed inside the housing 130 and the free end 102 of the cable 101 may be disposed outside the housing 130. In the first position, a maximum length of the cable 101 may be disposed within the housing 130. For example, the first position may define when the cable 101 is retracted, where most of the cable 101 is contained within the housing 130 for storage. In the second position, a minimum length of the cable 101 may be disposed within the housing 130. For example, the second position may define when the cable 101 is dispensed, where most of the cable 101 is outside the housing for use. It should be understood that some of the cable 101 may remain outside the housing 130 when the cable 101 is retracted, and some of the cable 101 may remain inside the housing 130 when the cable 101 is dispensed. Varying amounts of the cable 101 may be dispensed to remain outside of the housing 130, according to the demands of particular use cases. The amount of the cable 101 that can be dispensed from the housing 130 may be limited by industry standards. For example, some standards may limit the amount of the cable 101 that can be dispensed from the housing 130 to be under 25 ft. With the cable mechanism 100 of the present disclosure, more of the cable 101 may be usable compared to other cable management systems, because the minimum length of the cable 101 disposed in the housing 130 in the second position may be less than other cable management systems. In addition, more of the cable 101 may be managed within the housing 130 compared to other cable management systems, because the minimum length of the cable 101 disposed outside the housing 130 in the first position may be less than other cable management systems. This may avoid excess cable 101 remaining outside of the housing 130 when not in use.

The fixed end 105 of the cable 101 may be positioned anywhere within the housing 130, depending on system design. For example, the fixed end 105 of the cable 101 may be routed down to the base of the housing 130 to connect to an electric vehicle supply equipment (EVSE) system 140. The EVSE system 140 may be disposed within the housing 130 or may be an external component that is connectable to the fixed end 105 of the cable 101 within the housing 130. The location of the connection between the fixed end 105 of the cable 101 and the EVSE system 140 may be adjustable and can be changed depending on the position of the output and input of the cable mechanism 100 in the specific application. The free end 102 of the cable 101 may be connectable to a chargeable device (e.g., an electric vehicle (EV)). Thus, the EVSE 140 may be configured to charge the EV via the cable 101 and the cable mechanism 100.

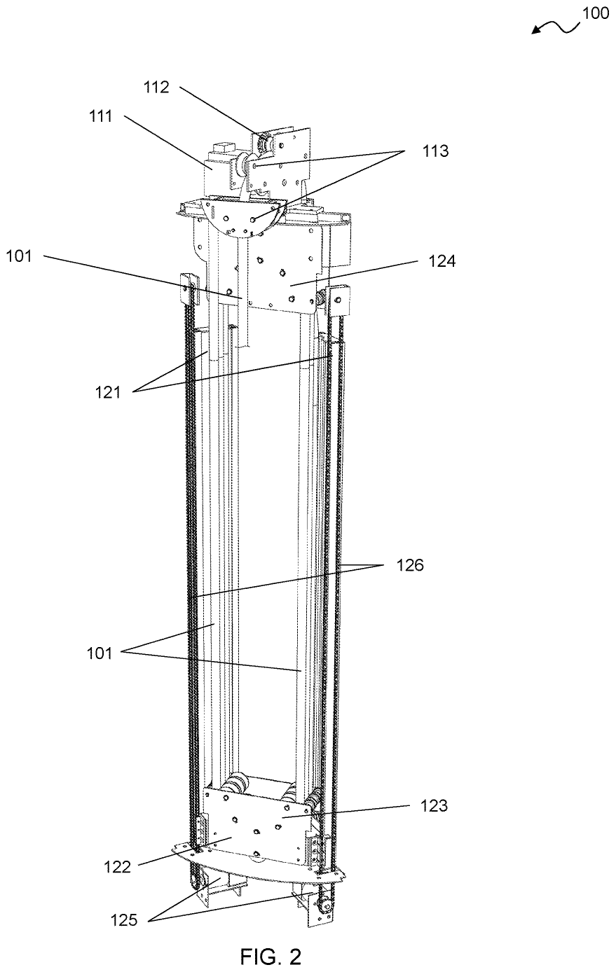

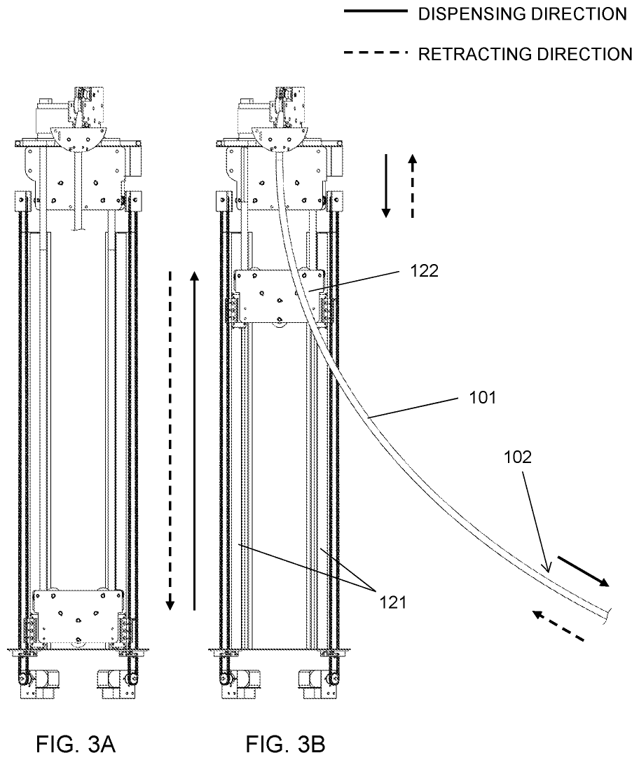

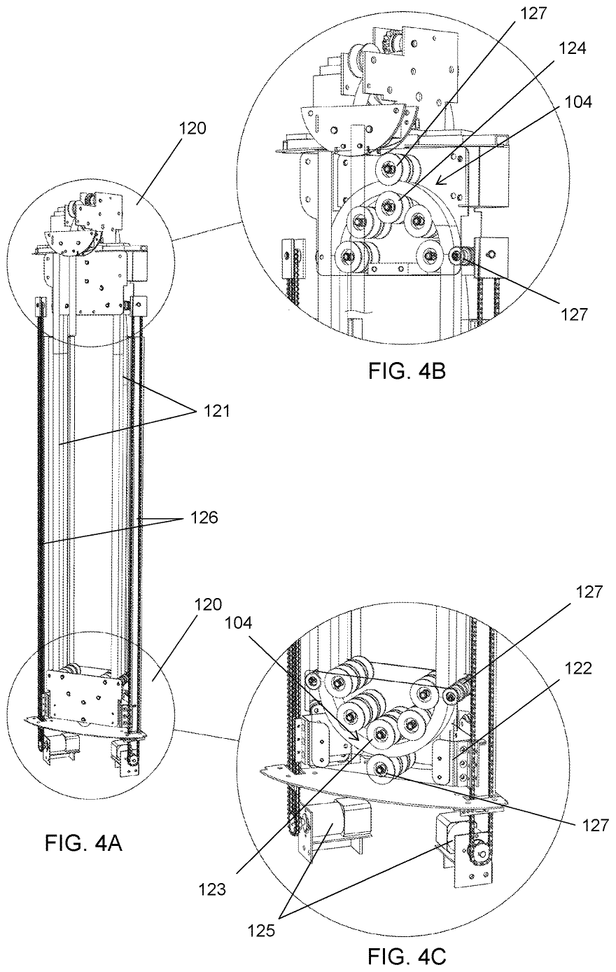

FIGS. 2-5 illustrate an exemplary cable mechanism 100 according to an embodiment of the present disclosure. Referring to FIG. 2, the pulley assembly 120 may comprise a linear motion guide 121, a carriage 122 movable along the linear motion guide 121 between the first position and the second position, at least one movable pulley 123 disposed on the carriage 122, and at least one stationary pulley 124 disposed adjacent to the motor assembly 110 above the carriage 122. The linear motion guide 121 may comprise one or more guide rails, pairs of guide rails, or any other linear motion guide mechanisms known in the art. The carriage 122 may move between the first position (shown in FIG. 3A) and the second position (shown in FIG. 3B) to change the vertical position of the movable pulley 123 as the cable 101 is moved in the dispensing direction or the retracting direction. As shown in FIGS. 4A, 4B, and 4C, the following portion 104 of the cable 101 may be looped around the at least one movable pulley 123 and the at least one stationary pulley 124 in series. When the carriage 122 is in the first position, the at least one movable pulley 123 and the at least one stationary pulley 124 may be separated by a maximum distance. As such, a maximum length of the cable 101 looped around the at least one movable pulley 123 and the at least one stationary pulley 124 may be contained within the housing 130 for storage. When the carriage 122 is in the second position, the at least one movable pulley 123 and the at least one stationary pulley 124 may be separated by a minimum distance. As such, a minimum length of the cable 101 may be looped around the at least one movable pulley 123 and the at least one stationary pulley 124, such that the remaining length of the cable 101 may be dispensed from the housing 130.

It should be understood that the movement of the pulley assembly 120 may allow more of the cable 101 to be dispensed and retracted from the cable mechanism 100 compared to fixed pulleys. For example, a fixed pulley system would require a fixed length of the cable to be looped around the pulleys at all times, which limits the length of cable that can be dispensed and stored. In contrast, the pulley assembly 120 of the present disclosure varies the length of the cable that is looped around the at least one movable pulley 123 and the at least one stationary pulley 124, which increases the length of the cable that can be dispensed and stored by the cable mechanism 100.

The carriage 122 may be motorized or pneumatically controlled. For example, the pulley assembly 120 may further comprise a drive motor 125 configured to drive a drive chain 126. The drive chain 126 may be a chain, belt (e.g., timing belt, synchronous belt, etc.), or spool of guide cable that can be driven by the drive motor 125. The carriage 122 may be fixed to the drive chain 126, such that when the drive motor 125 drives the drive chain 126, the carriage 122 moves along the linear motion guide 121 between the first position and the second position. While the exemplary cable mechanism 100 shown in FIGS. 2-5 includes two drive motors 125 configured to drive two drive chains 126, the cable mechanism 100 may be operable by a single drive motor 125 and single drive chain 126, and other configurations of moving the carriage 122 are within the scope of the present disclosure. The drive motor 125 may similarly be configured to move the carriage 122 by other lifting mechanisms (e.g., screw lift), and is not limited herein.

The pulleys of the pulley assembly 120 may have a sufficiently large diameter to minimize stress on the cable 101 during movement. For example, the at least one movable pulley 123 and the at least one stationary pulley 124 may have a diameter at least 5 times greater than the diameter of the cable 101. The ratio of the pulley diameter to the cable diameter may be greater than 5:1, e.g., the ratio may be 10:1, 12:1, or larger, and any ratio therebetween. If the ratio were smaller than 5:1, the cable 101 may need to more sharply bend around the pulleys, which can cause stress on the cable 101 and affect smooth operation of the cable mechanism 100. In some embodiments, the cable 101 may have a diameter of 10 mm to 80 mm. Accordingly, the at least one movable pulley 123 and the at least one stationary pulley 124 may have a diameter of 100 mm to 960 mm or larger. Where the stiffness of the cable 101 makes a loop of at least 5 times the diameter of the cable 101 difficult to achieve without undue tension, additional guide pulleys 127 can be used to ensure that the cable 101 fits inside the envelope provided by the pulley assembly. The guide pulleys 127 may be placed at a distance of 10 or more diameters of the cable 101 away from the mounting axis of the movable pulley 123 or the stationary pulley 124. Guide pulleys 127 can be placed alternately on tangent points to the pulley or cable bend arc to constrain the cable 101 to follow a desired path. The size of each of the pulleys of the pulley assembly 120 may depend on the interior space within the housing 130. In some embodiments, the at least one movable pulley 123 and the at least one stationary pulley 124 may be the same size. Alternatively, the at least one movable pulley 123 and the at least one stationary pulley 124 may be different sizes. Accordingly, the combinations of pulleys of the pulley assembly 120 may be sized and placed for smooth operation of the cable mechanism 100.

The pulley assembly 120 may include additional pulleys for additional cable loops and increase the available cable length. For example, the at least one movable pulley 123 may comprise a plurality of movable pulleys 123, and the at least one stationary pulley 124 may comprise a plurality of stationary pulleys 124. The following portion 104 of the cable 101 may be alternately looped around each one of the plurality of movable pulleys 123 and each one of the plurality of stationary pulleys 124 in series. The number of pulleys in the plurality of movable pulleys 123 may be n, and the number of pulleys in the plurality of stationary pulleys 124 may be m. In some embodiments, m=n. Alternatively, m=n±1. For example, the pulley assembly 120 may include 3 movable pulleys 123 and 2 stationary pulleys 124. Spacers may be provided between each of the plurality of movable pulleys 123 and each of the plurality of stationary pulleys 124 to maintain separation of the following portion 104 of the cable 101 between each loop. The sizes of each of the plurality of movable pulleys 123 and each of the plurality of stationary pulleys 124 may be consistent between each loop. Alternatively, sizes of each of the plurality of movable pulleys 123 and each of the plurality of stationary pulleys 124 may vary between each loop. In some instances, changing diameter between successive pulleys may maintain more uniform tension in the cable 101 compared to consistent sizes. Accordingly, the combinations and sizes of the pulleys of the pulley assembly 120 may vary for smooth operation of the cable mechanism 100.

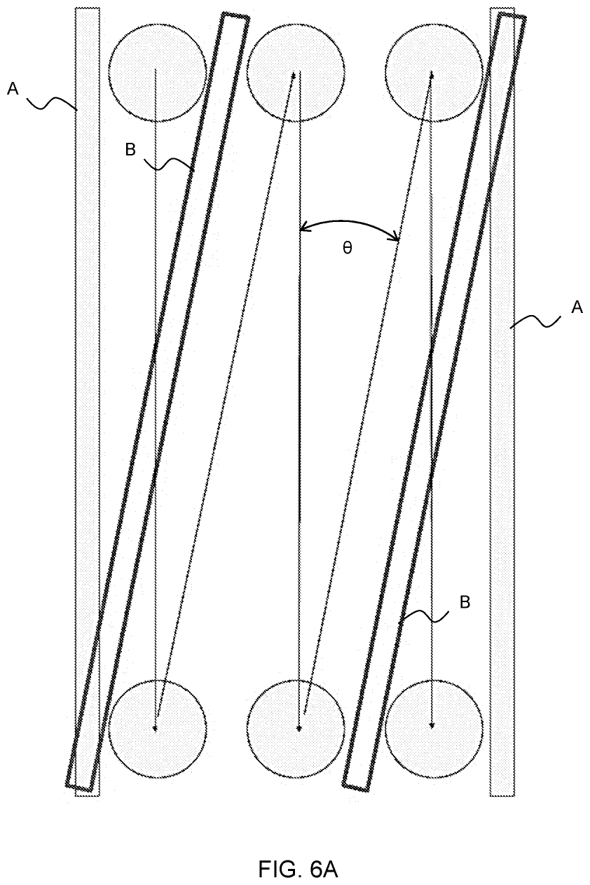

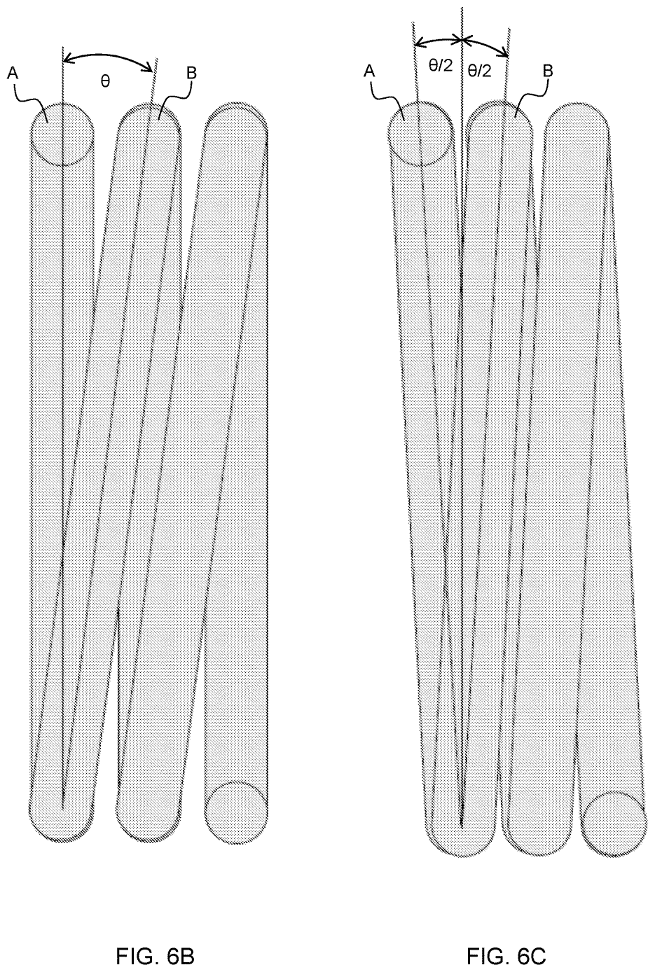

Each movable pulley 123 and each stationary pulley 124 may be non-parallel such that successive pulleys in each loop of the cable 101 have an input at a location that intersects a plane of a previous pulley. For example, as shown in FIG. 6A, one set of pulleys A may be offset at an angle θ relative to the other set of pulleys B. Accordingly, as the cable is looped around consecutive pulleys, the angle of the B pulleys allows the cable to exit the first A pulley at an angle to enter the next A pulley in the loop. The angle θ may depend on the sizes of the pulleys A and B and the spaces between each of the A pulleys and B pulleys. In some embodiments, the angle θ may be 5-15°. In some arrangements, one of the sets of pulleys A or B may be aligned with the orthogonal, with the other is offset at the angle θ relative to the orthogonal. For example, as shown in FIG. 6B, the cable looped around the set of pulleys A is aligned with the orthogonal, while the cable looped around the set of pulleys B is offset at the angle θ relative to the orthogonal. Alternatively, both the sets of pulleys A and B may be offset from the orthogonal, such that the sets of pulleys A and B are offset at the angle θ relative to each other. For example, as shown in FIG. 6C, the cable looped around both sets of pulleys A and B is offset at an angle θ/2 relative to the orthogonal, resulting in the offset angle θ. It should be understood that the sets of pulleys A and B may be offset by equal or different amounts from the orthogonal.

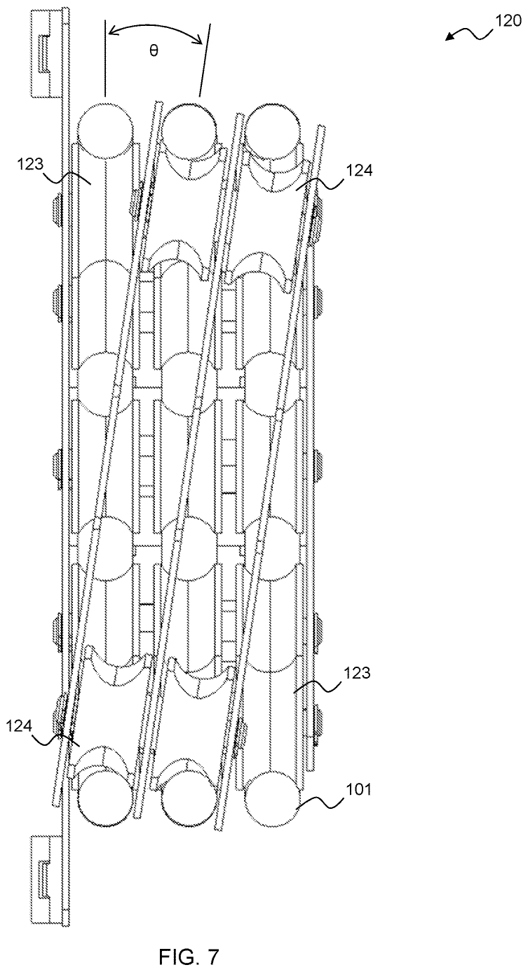

Either the plurality of movable pulleys 123 or the plurality of stationary pulleys 124 may be offset from the other. For example, in the embodiment shown in FIG. 7, the plurality of stationary pulleys 124 may be offset at the angle θ relative to the plurality of movable pulleys 123. Alternatively, the plurality of movable pulleys 123 may be offset at the angle θ relative to the plurality of stationary pulleys 124. The non-parallel arrangement of successive pulleys may result in smoother operation of the cable mechanism 100 compared to parallel pulleys, which may produce undue friction between the cable 101 and the pulleys if the cable 101 is of significant thickness, stiffness, or both. Cables 101 comprised of copper or aluminum wire of a diameter greater than 6 mm, or multi-conductor cables of a diameter greater than 10 mm in particular may have issues at discharge levels of 80% of the cable length or more, as the angle in which the cable 101 must bend between successive layers of pulleys can create undue force on the pulley edges, or if using plain rollers, can cause transverse forces that could cause the cable to unseat itself from the rollers. The minimum angle θ between successive pulleys may be determined by the cable diameter. For example, the minimum angle may be 6-8° degrees for a five-conductor cable of 16.4 mm diameter.

In some embodiments, each pulley of the pulley assembly 120 may comprise a series of pulleys arranged in an arc shape. For example, the at least one movable pulley 123 may comprise a series of pulleys arranged in an arc shape (shown in FIG. 4C), and the at least one stationary pulley 124 may comprise a series of pulleys arranged in an arc shape (shown in FIG. 4B). The arc shape may refer to a circular arc, non-circular arc, or any other arrangement of a conic section and is not limited herein. An arc of pulleys may be favorable to singular pulleys in a multi-layer configuration, as it maximizes the usage of the entrained cable in the system, by removing the limitation of movement of the pulleys to a perfect tangent position. For example, the two center points of the idealized pulley axis of a series of pulleys in an arc shape is only be separated by the sum of the largest two radii of the end edge pulleys in the top and bottom array, while two single pulleys increases this distance dramatically to the sum of the radius of both single pulleys, which in some embodiments may be at least 5 times the cable diameter. For example, a 10 mm cable system could have a pulley arc radius of 50 mm. The closest the two pulleys with this cable diameter would be 100 mm or larger. In the same instance where a series of smaller pulleys are used to create a pulley arc radius of 50 mm, the individual pulleys could have a radius of 10 mm, which allows the two pulley arcs to approach each other to a minimum of 20 mm. As the usable cable length is a function of the number of loops, the arc shaped series of pulleys may minimize the amount of cable 101 that must remain in the housing 130 and thereby increase the amount of cable 101 that can be dispensed from the housing 130 for use.

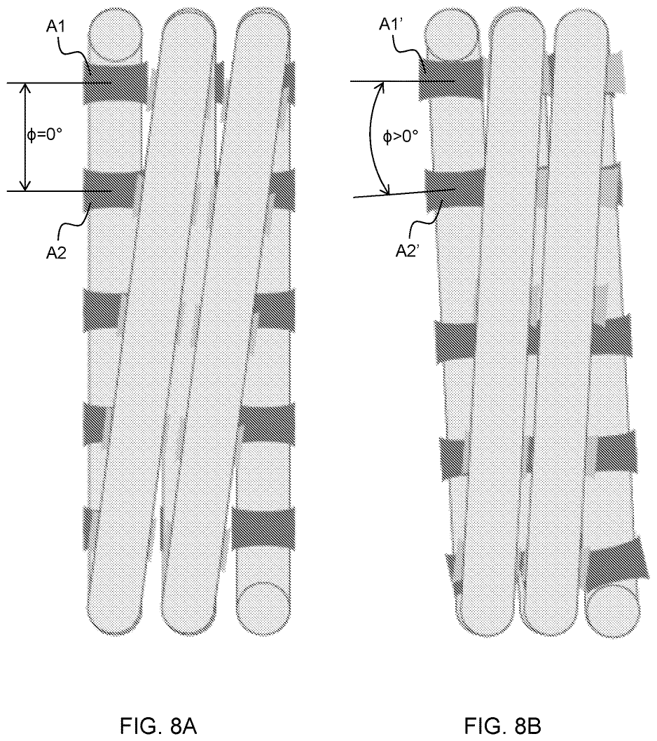

The axes of each pulley in the series of pulleys can be arranged such that the bearing surfaces of each pulley are perpendicular to the path of motion of the cable 101. For example, the angle between successive pulleys A1 and A2 may be defined by an angle φ. The angle φ may be defined by the diameter of the cable 101, and the sizes and arrangements of the pulleys. For example, as shown in FIG. 8A, the angle between successive pulleys A1 and A2 may be φ=0°. Alternatively, as shown in FIG. 8B, the angle between successive pulleys A1′ and A2′ may be φ>0°. Each of the series of pulleys of the at least one movable pulley 123 and the at least one stationary pulley 124 may be arranged such that the angle φ is consistent or varies between successive pulleys in each series or between each loop.

Each of the plurality of movable pulleys 123 may move independently or in conjunction with each other. In other words, the carriage 122 may be configured to move all of the plurality of movable pulleys 123 together, or the carriage 122 may be configured to move the plurality of movable pulleys 123 separately or consecutively. For example, in the exemplary cable mechanism 100 shown in FIGS. 4A-4C, each of the plurality of movable pulleys 123 may be disposed on the carriage 122, such that the carriage 122 simultaneously moves the plurality of moveable pulleys 123 between the second position and the first position. Alternatively, each of the plurality of movable pulleys 123 may be disposed on its own carriage (or separate movable parts of the carriage 122), such that each carriage can consecutively move each of the plurality of movable pulleys 123 between the second position and the first position. For example, starting with three movable pulleys 123 in the first position, the carriage 122 may move the first movable pulley to the second position, then the second movable pulley, and then the third movable pulley, after the previous pulley has moved to the second position or another position between the first position and the second position. In the same example, the carriage 122 may move the three movable pulleys 123 in reverse order (3, 2, 1) when moving back to the first position. Each carriage 122 may also be configured to move each of the plurality of movable pulleys 123 simultaneously, for quicker dispensing or retracting.

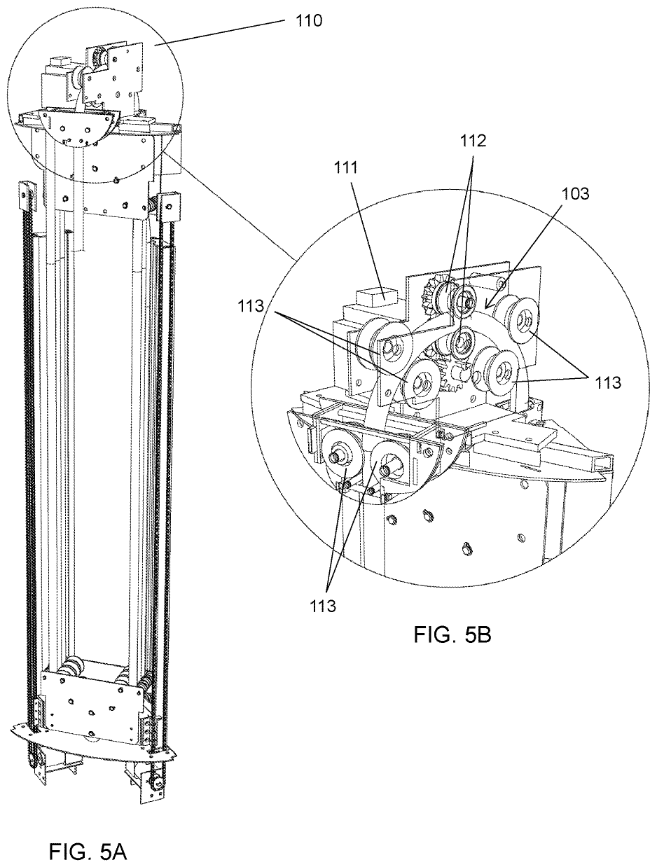

Referring to FIGS. 5A and 5B, the motor assembly 110 may comprise an exit motor 111 configured to drive a pair of drive rollers 112. The leading portion 103 of the cable 101 may be disposed between the drive rollers 112 such that when the exit motor 111 drives the pair of drive rollers 112, the free end 102 of the cable 101 is dispensed or retracted. For example, the space between the drive rollers 112 may be sized such that the leading portion 103 of the cable 101 is squeezed between the drive rollers 112, so rotation of the drive rollers 112 causes cable 101 to be dispensed or retracted based on the rotation directions of the drive rollers 112. Between the force imparted by the drive rollers 112 and the fixed end 105 of the cable 101, the cable 101 may be tensioned on the pulley assembly 120 at all times. The force imparted by the drive rollers 112 may also provide momentum to the cable 101 when dispensing or retracting. The motor assembly 110 may further comprise at least one pair of guide rollers 113 arranged upstream and/or downstream of the pair of drive rollers 112. The at least one pair of guide rollers 113 may configured to alter the angular direction in which the cable 101 is dispensed or retracted. For example, the pair of guide rollers 113 may direct the cable 101 out of the output opening 131 of the housing 130 for use.

The cable mechanism 100 may further comprise a controller 150 that is in electronic communication with the motor assembly 110 and the pulley assembly 120, as shown in FIG. 1. For example, the controller 150 may be configured to synchronize the operation of the drive motor 125 of the pulley assembly 120 and the exit motor 111 of the motor assembly 110. By synchronizing the movement of the drive motor 125 and the exit motor 111, the cable 101 can be kept under tension when dispensing and retracting. Without tension, the cable 101 may buckle when dispensing, resulting in the jamming or fouling of the cable mechanism 100. If the tension in the cable 101 is too large, the force required to drive the cable 101 may to be too large. As such, the controller 150 may be configured to control the speed of the drive motor 125 and the exit motor 111 to control the tension of the cable 101. For example, the controller 150 may control the speed of the drive motor 125 to be 5 to 15 percent slower than the speed of the exit motor 111 when the cable 101 is dispensing from the cable mechanism 100, and the controller 150 may control the speed of the drive motor 125 to be 15 to 30 percent slower than the speed of the exit motor 111 when the cable 101 is retracting from the cable mechanism 100. Alternatively, the controller 150 may control a ratio of speed of the exit motor 111 to a speed of the drive motor 125 to be about 5.5:1 to 6:1. Accordingly, the synchronous movement of drive motor 125 and the exit motor 111 may provide smooth operation of the cable mechanism while dispensing and retracting. It should be understood that the speeds of the drive motor 125 and the exit motor 111 may depend on the speeds of dispensing and retracting the cable 101 required for a particular application and is not limited herein. The relative speeds of the drive motor 125 and the exit motor 111 may remain constant, or may change as the pulley assembly 120 moves between the first position and the second position. The relative speeds of the drive motor 125 and the exit motor 111 may also depend on the gear ratios and transmissions of the pulley assembly 120 and the motor assembly 110, respectively, which could also be designed to provide tensioning effects. The number of loops of the cable 101 may also impact the relative speeds, e.g., more loops may result in a higher ratio of speeds, while fewer loops may result in a lower ratio, trending towards a 1:1 ratio for a single loop.

A control switch 155 may be provided to control the operation of the cable mechanism 100. The control switch 155 may be disposed at the free end 102 of the cable 101 and may be in electronic communication with the controller 150. For example, the control switch 155 may be in wireless communication with the controller 150, or the control switch 155 may be wired to the controller 150 via the cable 101. The control switch 155 may be configured to send instructions to the controller 150 to dispense or retract the cable 101. For example, the control switch 155 may instruct the controller 150 to control the exit motor 111 and the drive motor 125 to operate in corresponding directions to dispense or retract the cable 101. In some embodiments, the control switch 155 may be configured to send instructions to the controller 150 to dispense or retract a specified length of the cable 101 that is less than or equal to the maximum length of the cable 101 that can be dispensed from the housing 130. The specified length of the cable 101 may be one or more preset lengths or a user-defined length of the cable 101. The control switch 155 may be operable by a single button, by two buttons (one for each direction of the cable 101), or additional buttons configured to define a specified length of the cable 101 to be dispensed. Alternatively, the control switch 150 may be operable by pulling on the free end 102 of the cable 101.

With the cable mechanism 100 of the present disclosure, the cable 101 may be separated from itself by the pulley assembly 120. For example, the pulley assembly 120 may prevent lengths of the cable 101 from being layered on top of each other, as the following portion 104 of the cable 101 is looped around the movable pulley 123 and the stationary pulley 124. The movable pulley 123 may also be distanced from the stationary pulley 124 in the first position, and even in the second position, there may be no contact between lengths of the cable 101 in adjacent pulley layers. This may result in dramatically decreased heating of any individual portion of the cable 101, such that even in the retracted position, the entire ampacity of the cable 101 can be used. In the instance the rollers and roller support structure are made of even mildly thermally conductive materials, the dissipative effects may be significantly improved over a standard spooled cable. The cable mechanism 100 may provide a simple and controlled manner of dispensing and retracting a cable 101 that may be suitable for high-current EV charging applications.

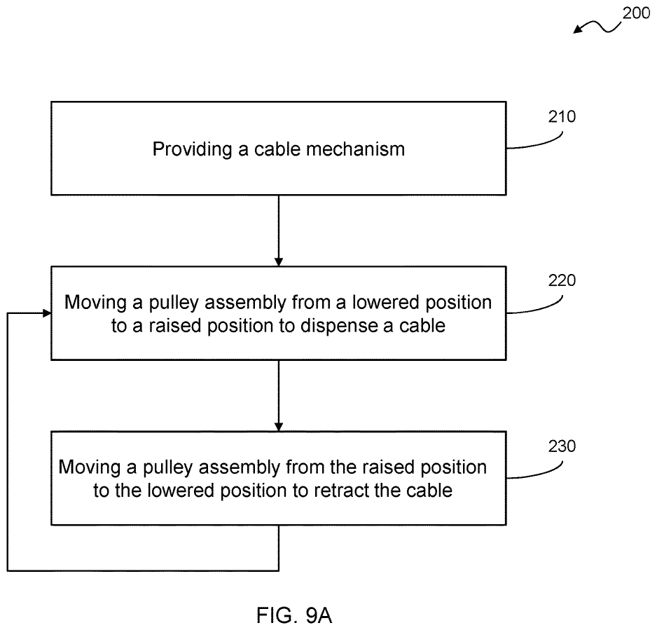

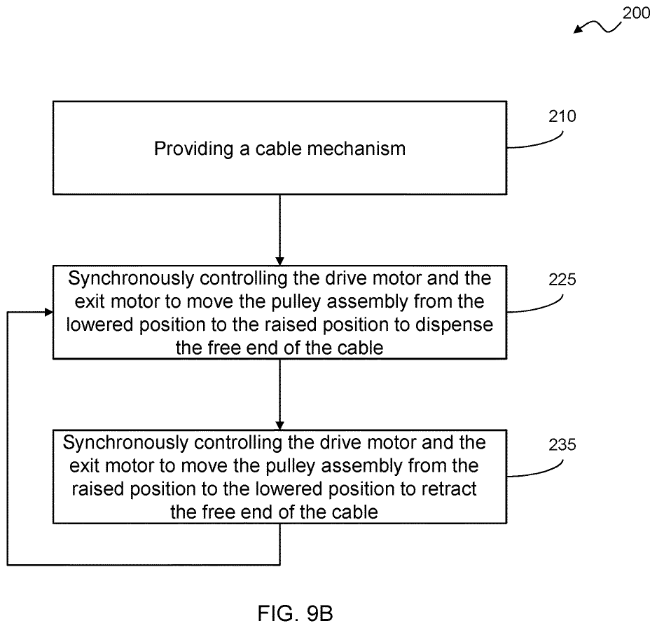

Another embodiment of the present disclosure provides a method 200 of dispensing or retracting a cable. As shown in FIG. 9A, the method 200 may comprise the following steps.

At step 210, a cable mechanism is provided. The cable mechanism may be the cable mechanism 100 described above, the details of which are not repeated again here.

At step 220, the pulley assembly is moved from the first position to the second position to dispense the cable. By moving to the second position, a length of the cable may be dispensed out of the cable mechanism, thereby providing additional length of usable cable.

At step 230, the pulley assembly is moved from the second position to the first position to retract the cable. By moving to the first position, a length of the cable may be retracted back into the cable mechanism, thereby providing efficient storage for the cable.

It should be understood that steps 220 and 230 may be repeated any number of times to dispense or retract the cable in a simple and efficient manner using the cable mechanism of the present disclosure. The second position and the first position referenced in steps 220 and 230 may refer to any relative positions and movements of the pulley assembly. In some embodiments, the second position and the first position may refer to the positions at the maximum range of movements of the pulley assembly or any positions within the range of movements. For example, the second position may correspond to a position of the pulley assembly in which a maximum amount of the cable is dispensed, and the first position may correspond to a position of the pulley assembly in which a minimum amount of the cable is dispensed. Alternatively, the second position and the first position may correspond to positions of the pulley assembly in which other amounts of the cable are dispensed, and the particular length of the cable that is dispensed in either position is not limited herein.

In some embodiments, the cable mechanism may include a drive motor configured to move the pulley assembly between the first position and the second position, an exit motor of the motor assembly configured to engage the leading portion of the cable to dispense or retract the cable, and a controller in electronic communication with the drive motor and the exit motor. Accordingly, as shown in FIG. 9B, steps 220 and 230 of the method 200 may be replaced with the following steps.

At step 225, the drive motor and the exit motor are synchronously controlled to move the pulley assembly from the first position to the second position to dispense the free end of the cable, such that the cable is under tension when dispensing. For example, the controller may control the speed of the drive motor to be 5 to 15 percent slower than the speed of the exit motor when the cable is dispensing from the cable mechanism.

At step 235, the drive motor and the exit motor are synchronously controlled to move the pulley assembly from the second position to the first position to retract the free end of the cable, such that the cable is under tension when retracting. For example, the controller may control the speed of the drive motor to be 15 to 30 percent slower than the speed of the exit motor when the cable is retracting from the cable mechanism.

With the method 200 of the present disclosure, the cable mechanism may be operated in a simple and controlled manner to dispense and retract a cable. Such a process may be highly repeatable and user friendly, such that it may be suitable for public EV charging applications.

Although the present disclosure has been described with respect to one or more particular embodiments, it will be understood that other embodiments of the present disclosure may be made without departing from the scope of the present disclosure. Hence, the present disclosure is deemed limited only by the appended claims and the reasonable interpretation thereof.

What is claimed is:

1. A cable mechanism for dispensing and retracting a cable having a free end and a fixed end, the cable mechanism comprising:
a motor assembly configured to engage a leading portion of the cable to dispense or retract the cable; and
a pulley assembly configured to engage a following portion of the cable, the following portion being arranged between the leading portion and the fixed end of the cable, wherein the pulley assembly is movable relative to the motor assembly between a first position and a second position;
wherein moving the pulley assembly from the first position to the second position dispenses the cable, and moving the pulley assembly from the second position to the first position retracts the cable.

2. The cable mechanism of claim 1, further comprising a housing, wherein the motor assembly is disposed in the housing and the pulley assembly is vertically movable relative to the motor assembly within the housing.

3. The cable mechanism of claim 2, wherein the housing is at least partially sealed, the fixed end of the cable being disposed inside the housing, and the free end of the cable being disposed outside the housing.

4. The cable mechanism of claim 2, wherein in the first position, a maximum length of the cable is disposed within the housing, and in the second position, a minimum length of the cable is disposed within the housing.

5. The cable mechanism of claim 1, wherein the pulley assembly comprises:
a linear motion guide;
a carriage movable along the linear motion guide between the first position and the second position;
at least one movable pulley disposed on the carriage; and
at least one stationary pulley disposed adjacent to the motor assembly;
wherein the following portion of the cable is looped around the at least one movable pulley and the at least one stationary pulley in series.

6. The cable mechanism of claim 5, wherein the pulley assembly further comprises a drive motor configured to drive a drive chain, wherein the carriage is fixed to the drive chain such that when the drive motor drives the drive chain, the carriage moves along the linear motion guide between the first position and the second position.

7. The cable mechanism of claim 5, wherein the at least one movable pulley and the at least one stationary pulley have a diameter at least 5 times greater than the diameter of the cable.

8. The cable mechanism of claim 5, wherein the at least one movable pulley and the at least one stationary pulley are non-parallel such that a successive pulley in each loop of the cable has an input at a location that intersects a plane of a previous pulley in the series.

9. The cable mechanism of claim 5, wherein the at least one movable pulley and the at least one stationary pulley each comprise a series of pulleys arranged in an arc shape, the arc shape having an arc radius at least 5 times greater than the radius of the cable.

10. The cable mechanism of claim 5, wherein the at least one movable pulley comprises a plurality of movable pulleys, the at least one stationary pulley comprises a plurality of stationary pulleys, and the following portion of the cable is alternately looped around one of the plurality of movable pulleys and one of the plurality of stationary pulley in series.

11. The cable mechanism of claim 1, wherein the motor assembly comprises an exit motor configured to drive a pair of drive rollers, wherein the leading portion of the cable is disposed between the pair of drive rollers such that when the exit motor drives the pair of drive rollers, the pair of drive rollers engage the leading potion of the cable to dispense or retract the free end of the cable.

12. The cable mechanism of claim 11, wherein the motor assembly further comprises at least one pair of guide rollers arranged upstream and/or downstream of the pair of drive rollers, wherein the at least one pair of guide rollers are configured to alter the angular direction in which the cable is dispensed or retracted.

13. The cable mechanism of claim 1, further comprising:
a drive motor configured to move the pulley assembly between the first position and the second position;
an exit motor of the motor assembly configured to dispense or retract the free end of the cable; and
a controller configured to synchronize the drive motor and the exit motor such that the cable is under tension between the leading portion and the fixed end when dispensing or retracting.

14. The cable mechanism of claim 13, wherein the controller is configured to control the speed of the drive motor to be slower than the speed of the exit motor when the cable is dispensing from the cable mechanism.

15. The cable mechanism of claim 13, wherein the controller is configured to control the speed of the drive motor to be slower than the speed of the exit motor when the cable is retracting from the cable mechanism.

16. The cable mechanism of claim 13, further comprising a control switch disposed at the free end of the cable, wherein the control switch is in electronic communication with the controller.

17. The cable mechanism of claim 16, wherein the control switch is configured to send instructions to the controller to dispense or retract the cable.

18. The cable mechanism of claim 17, wherein the control switch is configured to send instructions to the controller to dispense or retract a specified length of the cable.

19. A method of dispensing or retracting a cable having a free end and a fixed end, the method comprising:
providing a cable mechanism comprising:
a motor assembly configured to engage a leading portion of the cable to dispense or retract the cable; and
a pulley assembly configured to engage a following portion of the cable, the following portion being arranged between the leading portion and the fixed end of the cable, wherein the pulley assembly is movable relative to the motor assembly between a first position and a second position; and
moving the pulley assembly from the first position to the second position to dispense the cable, or moving the pulley assembly from the second position to the first position to retract the cable.

20. The method of claim 19, wherein moving the pulley assembly from the first position to the second position, or moving the pulley assembly from the second position to the first position comprises:
synchronously controlling a drive motor to move the pulley assembly between the first position and the second position and an exit motor of the motor assembly to dispense or retract the free end of the cable, such that the cable is under tension when dispensing or retracting.
